(19) United States
(12) Patent Application Publication
(10) Pub. No.: US 2022/0122506 A1
(43) Pub. Date: Apr. 21, 2022

(54) DISPLAY DEVICE AND TERMINAL

(71) Applicant: Shenzhen China Star Optoelectronics Semiconductor Display Technology Co., Ltd., Shenzhen, Guangdong (CN)

(72) Inventor: Xiang GAO, Shenzhen, Guangdong (CN)

(21) Appl. No.: 16/768,597

(22) PCT Filed: May 21, 2020
(86) PCT No.: PCT/CN2020/091456

§ 371 Date: May 29, 2020

(30) Foreign Application Priority Data
May 13, 2020 (CN) 202010401340.0

(51) Int. Cl. G09G 3/20

(52) U.S. Cl. CPC G09G 3/20; G09G 2310/027; G09G 2320/0223; G09G 2340/04; G09G 2310/0267

(57) ABSTRACT

The present application provides a display device and a terminal. In the display device, a drive chip is configured to store a first grayscale corresponding to a to-be-inputted data signal of an (i+1)-th row of subpixels within a first region and a first grayscale difference between a second grayscale corresponding to a first data signal inputted to an i-th row of subpixels and the first grayscale, and control a first data line to input a compensated second data signal to the i-th row of subpixels before the (i+1)-th row of subpixels are turned on. The present application alleviates a mis-charging phenomenon.

### FIELD OF THE DISCLOSURE

The present invention relates to display technologies, and more particularly to a display device and a terminal.

### DESCRIPTION OF RELATED ARTS

As the size of display panels becomes larger and larger, refresh rate becomes higher and higher. For ultra large display panels, scan signals on scan lines will have a resistance capacitance delay (RC Delay), which makes the data signals meant to be written to a next row of subpixels write to a current row of subpixels, that is, a mis-charging phenomenon occurs. This results in an unclear boundary between adjacent rows of subpixels and affects display effect.

Therefore, the existing display devices have a technical problem of unclear boundary between adjacent rows of subpixels and need to be improved.

### Technical Problems

Embodiments of the present application provide a display device and a terminal for alleviating the technical problem of unclear boundary between adjacent rows of subpixels in existing display devices.

### Technical Solutions

To solve above problems, the technical solutions provide in the present application are described below.

The present application provides a display device, including:

a plurality of subpixels, arranged in an array within a display region;

a plurality of scan lines, extending along a horizontal direction, wherein the scan lines are disposed at intervals along a vertical direction, each scan line connects to a row of subpixels, and at work stage, the plurality of scan lines input scan signals row by row to control the plurality of subpixels to be turned on row by row;

a plurality of data lines, perpendicular to the scan lines, wherein the data lines are disposed at intervals along the horizontal direction, each data line connects to a column of subpixels, and at work stage, the plurality of data lines input data signals to control the turned-on subpixels to display images under grayscales corresponding to the data signals; and

a drive chip, configured to store a first grayscale corresponding to a to-be-inputted data signal of an (i+1)-th row of subpixels within a first region, wherein a distance between the first region and scan signal input ends of the scan lines is greater than a threshold, the first region includes at least one column of subpixels, and wherein after obtaining a first grayscale difference between a second grayscale corresponding to a first data signal inputted to an i-th row of subpixels within the first region and the first grayscale, the drive chip is further configured to control a first data line corresponding to the subpixels within the first region to input a compensated second data signal to the i-th row of subpixels based on the first grayscale difference before the (i+1)-th row of subpixels are turned on.

In the display device of the present application, the drive chip is configured to control the first data line to input the compensated second data signal to the i-th row of subpixels, where a third grayscale corresponding to the second data signal is greater than the second grayscale when the first grayscale difference is a positive value.

In the display device of the present application, the drive chip is configured to control the first data line to input the compensated second data signal to the i-th row of subpixels, where a third grayscale corresponding to the second data signal is less than the second grayscale when the first grayscale difference is a negative value.

In the display device of the present application, the drive chip is configured to look up, after obtaining the first grayscale difference, a compensation table to obtain a target grayscale corresponding to the first grayscale difference, and control the first data line to input the second data signal to the i-th row of subpixels, where a data signal corresponding to the target grayscale is taken as the second data signal.

In the display device of the present application, the drive chip is configured to look up, after obtaining the first grayscale difference, a compensation table to obtain a second grayscale difference corresponding to the first grayscale difference, add up the second grayscale difference and the first grayscale difference to obtain a target grayscale, and control the first data line to input the second data signal to the i-th row of subpixels, where a data signal corresponding to the target grayscale is taken as the second data signal.

In the display device of the present application, the drive chip is configured to calculate, after obtaining the first grayscale difference, to obtain the second data signal, and control the first data line to input the second data signal to the i-th row of subpixels.

In the display device of the present application, the first region is equal to the display region in size.

In the display device of the present application, the scan signal input ends are disposed at a left side or a right side of the display device and the first region is located within the display region at one side away from the scan signal input ends.

In the display device of the present application, the scan signal input ends are disposed at a left side and a right side of the display device and the first region is located at a middle part of the display region.

In the display device of the present application, the drive chip is configured to store the first grayscale corresponding to the to-be-inputted data signal of the (i+1)-th row of subpixels within the first region in a buffer.

The present application further provides a terminal, including a display device and a housing, the display device including:

a plurality of subpixels, arranged in an array within a display region;

a plurality of scan lines, extending along a horizontal direction, wherein the scan lines are disposed at intervals along a vertical direction, each scan line connects to a row of subpixels, and at work stage, the plurality of scan lines input scan signals row by row to control the plurality of subpixels to be turned on row by row;

a plurality of data lines, perpendicular to the scan lines, wherein the data lines are disposed at intervals along the horizontal direction, each data line connects to a column of subpixels, and at work stage, the plurality of data lines input data signals to control the turned-on subpixels to display images under grayscales corresponding to the data signals; and

a drive chip, configured to store a first grayscale corresponding to a to-be-inputted data signal of an (i+1)-th row of subpixels within a first region, wherein a distance between the first region and scan signal input ends of the scan lines is greater than a threshold, the first region includes at least one column of subpixels, and wherein after obtaining a first grayscale difference between a second grayscale corresponding to a first data signal inputted to an i-th row of subpixels within the first region and the first grayscale, the drive chip is further configured to control a first data line corresponding to the subpixels within the first region to input a compensated second data signal to the i-th row of subpixels based on the first grayscale difference before the (i+1)-th row of subpixels are turned on.

In the terminal of the present application, the drive chip is configured to control the first data line to input the compensated second data signal to the i-th row of subpixels, where a third grayscale corresponding to the second data signal is greater than the second grayscale when the first grayscale difference is a positive value.

In the terminal of the present application, the drive chip is configured to control the first data line to input the compensated second data signal to the i-th row of subpixels, where a third grayscale corresponding to the second data signal is less than the second grayscale when the first grayscale difference is a negative value.

In the terminal of the present application, the drive chip is configured to look up, after obtaining the first grayscale difference, a compensation table to obtain a target grayscale corresponding to the first grayscale difference, and control the first data line to input the second data signal to the i-th row of subpixels, where a data signal corresponding to the target grayscale is taken as the second data signal.

In the terminal of the present application, the drive chip is configured to look up, after obtaining the first grayscale difference, a compensation table to obtain a second grayscale difference corresponding to the first grayscale difference, add up the second grayscale difference and the first grayscale difference to obtain a target grayscale, and control the first data line to input the second data signal to the i-th row of subpixels, where a data signal corresponding to the target grayscale is taken as the second data signal.

In the terminal of the present application, the drive chip is configured to calculate, after obtaining the first grayscale difference, to obtain the second data signal, and control the first data line to input the second data signal to the i-th row of subpixels.

In the terminal of the present application, the first region is equal to the display region in size.

In the terminal of the present application, the scan signal input ends are disposed at a left side or a right side of the display device and the first region is located within the display region at one side away from the scan signal input ends.

In the terminal of the present application, the scan signal input ends are disposed at a left side and a right side of the display device and the first region is located at a middle part of the display region.

In the terminal of the present application, the drive chip is configured to store the first grayscale corresponding to the to-be-inputted data signal of the (i+1)-th row of subpixels within the first region in a buffer.

### Beneficial Effects

The beneficial effects of the present application are described as follows. The present application provides a display device and a terminal. The display device includes a plurality of subpixels, a plurality of scan lines, a plurality of data lines and a drive chip; the plurality of subpixels, arranged in an array within a display region; the plurality of scan lines, extending along a horizontal direction, wherein the scan lines are disposed at intervals along a vertical direction, each scan line connects to a row of subpixels, and at work stage, the plurality of scan lines input scan signals row by row to control the plurality of subpixels to be turned on row by row; the plurality of data lines, perpendicular to the scan lines, wherein the data lines are disposed at intervals along the horizontal direction, each data line connects to a column of subpixels, and at work stage, the plurality of data lines input data signals to control the turned-on subpixels to display images under grayscales corresponding to the data signals; and the drive chip, configured to store a first grayscale corresponding to a to-be-inputted data signal of an (i+1)-th row of subpixels within a first region, wherein a distance between the first region and scan signal input ends of the scan lines is greater than a threshold, the first region includes at least one column of subpixels, and wherein after obtaining a first grayscale difference between a second grayscale corresponding to a first data signal inputted to an i-th row of subpixels within the first region and the first grayscale, the drive chip is further configured to control a first data line corresponding to the subpixels within the first region to input a compensated second data signal to the i-th row of subpixels based on the first grayscale difference before the (i+1)-th row of subpixels are turned on. In the present application, before turning on the (i+1)-th row of subpixels within the first region, the i-th row of subpixels within the first region will be compensated based on the first grayscale difference obtained by the drive chip and then the data signal of the (i+1)-th row of subpixels is inputted such that the compensating data signals and the mis-charging data signals of the i-th row of subpixels are cancelled mutually. In such a way, a mis-charging phenomenon is alleviated such that the boundary between adjacent rows of subpixels is clear and display effect is improved.

### DESCRIPTION OF DRAWINGS

For explaining the technical solutions used in the existing arts or the embodiments more clearly, the appended figures to be used in describing the existing arts or the embodiments will be briefly introduced in the following. Obviously, the appended figures described below are only some of the embodiments of the application, and those of ordinary skill in the art can further obtain other figures according to these figures without making any inventive effort.

FIG. 1 is a structural schematic diagram illustrating a flat view of a display device provided in an embodiment of the present application.

FIG. 2 is a schematic diagram illustrating changes of a wave when RC delay occurs in scan signals for a display device provided in an embodiment of the present application.

FIG. 3 is a schematic diagram illustrating mis-charging in a display device of an existing art.

FIG. 4 is a schematic diagram illustrating the condition of boundary between adjacent rows of subpixels in a display device of an existing art.

FIG. 5 is a schematic diagram illustrating an improvement on mis-charging in a display device of the present application.

FIG. 6 is a schematic diagram illustrating the condition of boundary between adjacent rows of subpixels in a display device of the present application.

FIG. 7 is a schematic diagram illustrating a drive chip in a display device of the present application.

### DESCRIPTION OF EMBODIMENTS OF THE DISCLOSURE

The following descriptions for the respective embodiments are specific embodiments capable of being implemented for illustrations of the present application with referring to the appended figures. In describing the present application, spatially relative terms such as “upper”, “lower”, “front”, “back”, “left”, “right”, “inner”, “outer”, “lateral”, and the like, may be used herein for ease of description as illustrated in the figures. Therefore, the spatially relative terms used herein are intended to illustrate the present application for ease of understanding, but are not intended to limit the present application. In the appended figures, units with similar structures are indicated by same reference numbers.

Embodiments of the present application provide a display device and a terminal for alleviating the technical problem of unclear boundary between adjacent rows of subpixels in existing display devices.

The present application provides a display device including a plurality of subpixels, a plurality of scan lines, a plurality of data lines and a drive chip; the plurality of subpixels, arranged in an array within a display region; the plurality of scan lines, extending along a horizontal direction, wherein the scan lines are disposed at intervals along a vertical direction, each scan line connects to a row of subpixels, and at work stage, the plurality of scan lines input scan signals row by row to control the plurality of subpixels to be turned on row by row; the plurality of data lines, perpendicular to the scan lines, wherein the data lines are disposed at intervals along the horizontal direction, each data line connects to a column of subpixels, and at work stage, the plurality of data lines input data signals to control the turned-on subpixels to display images under grayscales corresponding to the data signals; and the drive chip, configured to store a first grayscale corresponding to a to-be-inputted data signal of an (i+1)-th row of subpixels within a first region, wherein a distance between the first region and scan signal input ends of the scan lines is greater than a threshold, the first region includes at least one column of subpixels, and wherein after obtaining a first grayscale difference between a second grayscale corresponding to a first data signal inputted to an i-th row of subpixels within the first region and the first grayscale, the drive chip is further configured to control a first data line corresponding to the subpixels within the first region to input a compensated second data signal to the i-th row of subpixels based on the first grayscale difference before the (i+1)-th row of subpixels are turned on.

As shown in FIG. 1, in the display device of the present application, the plurality of subpixels 10 are arranged in an array within a display region to form a plurality of rows and a plurality of columns. G1, G2, . . . , Gi, Gi+1, . . . , Gn indicate a first, a second, . . . , an i-th, an (i+1)-th, . . . , a n-th scan lines that are disposed at intervals from top to bottom along a vertical direction, where i and n are positive integers and i<n. The scan lines extend along a horizontal direction. D1, D2, . . . , Dj, Dj+1, . . . , Dm indicate a first, a second, . . . , an i-th, an (i+1)-th, . . . , a n-th data lines that are disposed at intervals from left to right along the horizontal direction, where j and m are positive integers and j<m. The data lines are perpendicular to the scan lines, that is, the data lines extend along the vertical direction. Each scan line connects to a row of subpixels 10. In the row, each subpixel 10 includes a pixel driving circuit. After the display device gets into work stage, a signal output end of the scan line inputs a gate signal Gate to the pixel driving circuits to turn on m subpixels in a corresponding row. Data signals Data are inputted to the pixel driving circuits of the subpixels 10 in the row by means of m data lines such that the subpixels 10 display images under grayscales corresponding to the data signals Data.

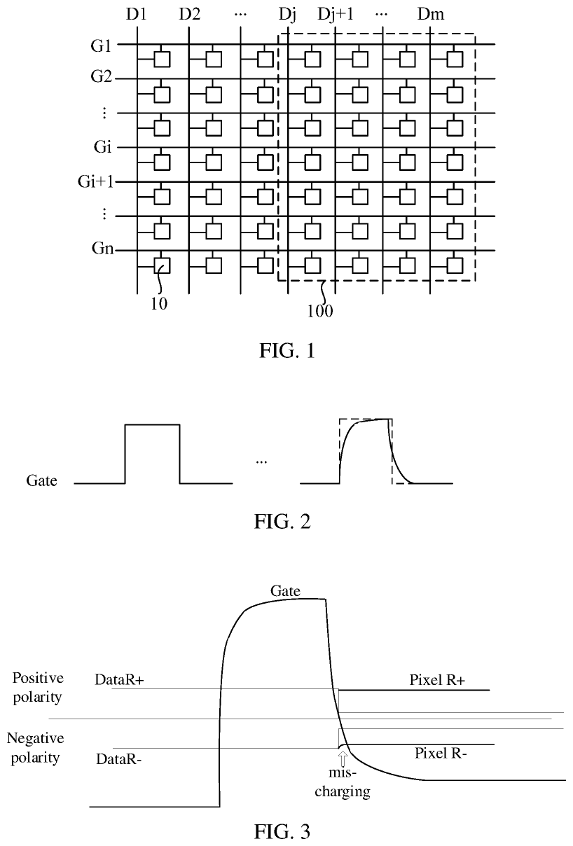

As shown in FIG. 2, a scan signal Gate of a same scan line inputted from the left side is used to turn on a whole row of subpixels 10. However, in a large-scaled display panel, the scan signal Gate is inputted from the left to the right with a large separated distance and thus, resistance/capacitance delay (RC delay) occurs such that the square wave will change.

When writing data signals to a certain row of subpixels is finished, the data lines will write data signals into a next row of subpixels. However, for a scan line corresponding to a current row of subpixels, the scan signal cannot reach a switched-off potential immediately. Instead, it needs a period of time to reach the potential. Accordingly, when writing data to a next row of subpixels, the current row of subpixels are still in a turned-on state, and the data signals meant to be written to the next row of subpixels will have some be written to the current row of subpixels, that is, mis-charging occurs.

As shown in FIG. 3, in an existing liquid crystal display panel, when the data signals written to a certain row of subpixels are with negative polarity indicated by Data R−, the data signals written to a next row of subpixels will be with positive polarity. Because of the RC delay of the scan signals, the positive data signals meant to be written to the next row of subpixels will have some be written to the current row of subpixels, making the potential Pixel R− of the current row of subpixels much higher. Similarly, when the data signals written to a certain row of subpixels are with positive polarity indicated by Data R+, the data signals written to a next row of subpixels will be with negative polarity. Because of the RC delay of the scan signals, the negative data signals meant to be written to the next row of subpixels will have some be written to the current row of subpixels, making the potential Pixel R+ of the current row of subpixels much lower.

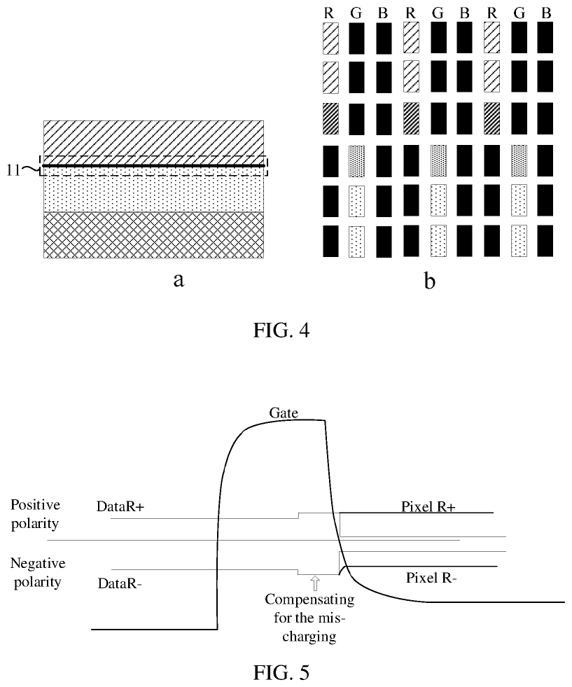

As shown in FIG. 4, nine rows of subpixels are extracted from an existing display panel, where each row of subpixels include red subpixels R, green subpixels G and blue subpixels B. The green subpixels G and the blue subpixels B are turned off and only the red subpixels R are turned on for those in the first to the third rows of subpixels, and thus the three rows of subpixels show a red color; the red subpixels R and the blue subpixels B are turned off and only the green subpixels G are turned on for those in the fourth to the sixth rows of subpixels, and thus the three rows of subpixels show a green color; the red subpixels R and the green subpixels G are turned off and only the blue subpixels B are turned on for those in the seventh to the ninth rows of subpixels, and thus the three rows of subpixels show a blue color. Meanwhile, the display panel shows three strips of red, green and blue colors, as shown in Part a of FIG. 4.

For ease of description, first six rows of subpixels are taken for illustrations, as indicated in Part b of FIG. 4. For a first column of red subpixels R, from top to bottom, the third row of red subpixels R are in a turned-on state and the fourth row of red subpixels R are in a turned-off state, that is, the grayscales of the fourth row of red subpixels R are in a decreasing state. Meanwhile, for the fourth row of red subpixels R, the data signals inputted by the data lines are with negative polarity. When the RC delay occurs for the scan signals of the scan lines, the negative data signals meant to be inputted to the fourth row of red subpixels R will mis-charge the third row of red subpixels R, making the third row of subpixels R appear darker.

For a second column of green subpixels G, from top to bottom, the third row of green subpixels G are in a turned-off state and the fourth row of green subpixels G are in a turned-on state. Meanwhile, for the fourth row of green subpixels G, the RC delay occurs for the scan signals of the scan lines. The scan signals cannot reach a switched-on potential immediately. Instead, it needs a period of time to reach the potential. Accordingly, the charging time of the fourth row of green subpixels G is too short, resulting in insufficient charging and appearing darker for the brightness.

Simultaneously affected by the insufficient charging and the mis-charging, the boundary between the two rows of subpixels within a region 11 where the third row of subpixels and the fourth row of subpixels are located become unclear, resulting in dark lines and affecting display effects. There is a corresponding compensating approach in the existing art for the insufficient charging. The way of compensation in the present application is primarily for the mis-charging problem.

As shown in FIG. 1, in the display device provided in an embodiment of the present application, a plurality of subpixels 10 are arranged in an array within a display region. At least one column of subpixels are located in a first region 100. A distance between the first region 100 and scan signal input ends of the scan lines is greater than a threshold. That is, the subpixels within the first region 100 is distanced away from the scan signal input ends. The RC delay will occur for the scan signals. Accordingly, compensation may be made for the subpixels within the region. The threshold will be different for different types and sizes of machines. The data lines correspondingly used for inputting data signals to the subpixels within the first region 100 are first data lines.

In an embodiment, the first region 100 is equal to the display region in size. That is, the compensation is made for all the subpixels in the display device.

In an embodiment, the scan signal input ends are disposed at a left side or a right side of the display device and the first region 100 is located within the display region at one side away from the scan signal input ends. Meanwhile, the display device adopts a single-side scan approach. When the scan signal input ends are at the left side of the display device, the first region 100 is located at the right side within the display region and its distance to the scan signal input ends is greater than the threshold. When the scan signal input ends are at the right side of the display device, the first region 100 is located at the left side within the display region and its distance to the scan signal input ends is greater than the threshold.

In an embodiment, the scan signal input ends are disposed at a left side and a right side of the display device and the first region is located at a middle part of the display region. Meanwhile, the display device adopts a double-side scan approach. The first region 100 is located at the middle part of the display region and both of its distance to the scan signal input ends of the left side and its distance to the scan signal input ends of the right side are greater than the threshold.

In the present application, after the display device gets into the work stage, the drive chip is used to store a first grayscale corresponding to a to-be-inputted data signal of an (i+1)-th row of subpixels within the first region 100. That is, before inputting a data signal to the (i+1)-th row of subpixels, the first grayscale difference corresponding to the data signal is stored or saved. Then, the drive chip obtains a first grayscale difference between a second grayscale corresponding to a first data signal inputted to an i-th row of subpixels within the first region 100 and the first grayscale, controls a first data line corresponding to the subpixels within the first region 100 to input a compensated second data signal to the i-th row of subpixels based on the first grayscale difference before the (i+1)-th row of subpixels are turned on.

In the first region 100, the RC delay occurs in the scan signals. The data signals for the (i+1)-th row will mis-charge the i-th row of subpixels. In the present application, before turning on the (i+1)-th row of subpixels within the first region 100, the i-th row of subpixels within the first region 100 will be compensated based on the first grayscale difference obtained by the drive chip such that the data signals mis-charging the i-th row of subpixels are offset. Then, the data signals for the (i+1)-th row of subpixels are inputted. In such a way, a mis-charging phenomenon is alleviated such that the boundary between adjacent rows of subpixels is clear and display effect is improved.

In an embodiment, the drive chip is configured to control the first data line to input the compensated second data signal to the i-th row of subpixels, where a third grayscale corresponding to the second data signal is greater than the second grayscale when the first grayscale difference is a positive value.

As shown in FIG. 5, a grayscale corresponding to the to-be-inputted data signal of the (i+1)-th row of subpixels is the first grayscale and a grayscale corresponding to the first data signal inputted to the i-th row of subpixels is the second grayscale. The drive chip obtains the first grayscale difference between the second grayscale and the first grayscale. When the first grayscale difference is a positive value, it indicates that the data signal of the i-th row of subpixels within the first region 100 is with positive polarity, indicated by Data R+, while the data signal of the (i+1)-th row of subpixels is with negative polarity. The negative data signal of the (i+1)-th row of subpixels would mis-charge the i-th row of subpixels, making the i-th row of subpixels appear darker. Meanwhile, the drive chip controls the first data line to input the compensated second data signal to the i-th row of subpixels, where a third grayscale corresponding to the second data signal is greater than the second grayscale. That is, the i-th row of subpixels is processed by over-charging such that the potential Pixel R+ of the i-th row of subpixels is lifted up. The difference between the second data and the first data will offset the negative data signal mis-charging the i-th row of subpixels. In such a way, it is able to adjust the brightness of the i-th row of subpixels to a normal level.

In an embodiment, the drive chip is configured to control the first data line to input the compensated second data signal to the i-th row of subpixels, where a third grayscale corresponding to the second data signal is less than the second grayscale when the first grayscale difference is a negative value.

As shown in FIG. 5, the drive chip obtains the first grayscale difference between the second grayscale and the first grayscale. When the first grayscale difference is a negative value, it indicates that the data signal of the i-th row of subpixels within the first region 100 is with negative polarity, indicated by Data R−, while the data signal of the (i+1)-th row of subpixels is with positive polarity. The positive data signal of the (i+1)-th row of subpixels would mis-charge the i-th row of subpixels, making the i-th row of subpixels appear brighter. Meanwhile, the drive chip controls the first data line to input the compensated second data signal to the i-th row of subpixels, where a third grayscale corresponding to the second data signal is less than the second grayscale. In such a way, the potential Pixel R− of the i-th row of subpixels is lowered. The difference between the second data and the first data will offset the positive data signal mis-charging the i-th row of subpixels. Accordingly, it is able to adjust the brightness of the i-th row of subpixels to a normal level.

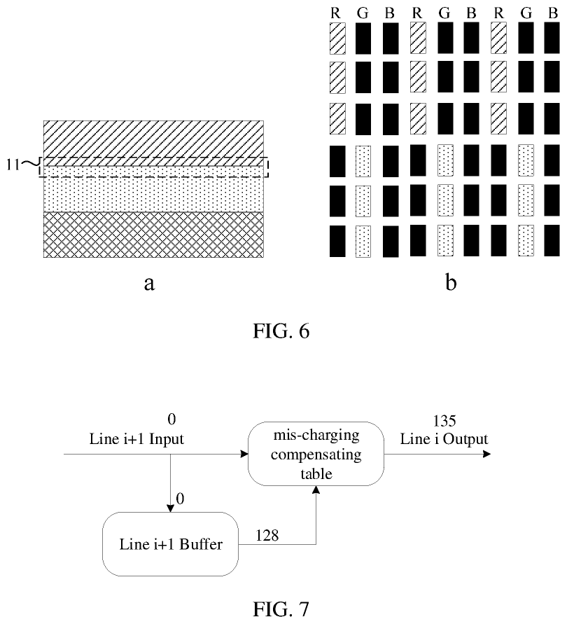

As shown in FIG. 6, when utilizing a same lighting way as FIG. 4, the display panel shows three strips of red, green and blue colors as well, as shown in Part a of FIG. 6. For ease of description, similarly, first six rows of subpixels are taken for illustrations, as indicated in Part b of FIG. 6. An existing compensation approach is utilized for compensating the insufficient charging of the green subpixels G. For the mis-charging phenomenon of red subpixels R, before inputting the to-be-inputted data signals to the fourth row of red subpixels R, the first grayscale corresponding to the to-be-inputted data signal is stored in the drive chip and then, the drive chip obtains the first grayscale difference between the second grayscale corresponding to the first data signal of the third row of red subpixels R and the first grayscale. Since the third row of red subpixels R are in a turned-on state and the fourth row of red subpixels R are in a turned-off state, that is, the grayscale of the fourth row of red subpixels R is in a decreasing state, the first grayscale difference is a positive value, and the drive chip controls the first data line to input the compensated second data signal to the third row of subpixels, where the third grayscale corresponding to the second data signal is greater than the second grayscale, making the brightness of the third row of red subpixels R increase. In such a way, in a region where the third row of subpixels and the fourth row of subpixels, the boundary between the two rows of subpixels is clear, dark lines will not appear, and the display effect is improved.

It can be known from above embodiments that after obtaining the first grayscale difference, the drive chip controls the first data line to input a third data signal to the i-th row of subpixels based on a plus or minus sign of the first grayscale difference for compensating the mis-charging of the i-th row of subpixels, making it brightness be at a normal level. When the drive chip controls the first data line to input the third data signal, any specific value of the third data signal may be obtained through different ways.

In an embodiment, the drive chip is configured to look up, after obtaining the first grayscale difference, a compensation table to obtain a target grayscale corresponding to the first grayscale difference, and control the first data line to input the second data signal to the i-th row of subpixels, where a data signal corresponding to the target grayscale is taken as the second data signal.

As shown in FIG. 7, it is assumed that the first grayscale corresponding to the to-be-inputted data signal of the (i+1)-th row of subpixels is 0 and the second grayscale corresponding to the first data signal of the i-th row of subpixels is 128. Before the data signal of the (i+1)-th row of subpixels within the first region 100 is inputted, the first grayscale 0 corresponding to this data signal is stored in a buffer of the driving signal. Then, the drive chip obtains the first grayscale difference 128 between the second grayscale 128 corresponding to the first data signal inputted to the i-th row of subpixels within the first region 100 and the first grayscale 0. The first grayscale difference 128 is a positive value. This indicates that the grayscale of the (i+1)-th row of subpixels decreases with respect to the i-th row. After obtaining the first grayscale difference 128, the drive chip obtains a target grayscale 135 corresponding to the first grayscale difference 128 from a compensation table. The target grayscale refers to a grayscale making the brightness of the i-th row of subpixels normal. The compensation table is a mis-charging compensating table prestored in the drive chip. After the target grayscale 135 is obtained by looking up the table, the first data line is controlled to input the second data signal to the i-th row of subpixels, where a data signal corresponding to the target grayscale 135 is taken as the second data signal.

In an embodiment, the drive chip is configured to look up, after obtaining the first grayscale difference, a compensation table to obtain a second grayscale difference corresponding to the first grayscale difference, add up the second grayscale difference and the first grayscale difference to obtain a target grayscale, and control the first data line to input the second data signal to the i-th row of subpixels, where a data signal corresponding to the target grayscale is taken as the second data signal. Meanwhile, the drive chip first obtains the first grayscale difference 128 between the second grayscale 128 corresponding to the first data signal inputted to the i-th row of subpixels within the first region 100 and the first grayscale 0. The first grayscale difference 128 is a positive value. This indicates that the grayscale of the i-th row of subpixels decreases with respect to the i-th row. After obtaining the first grayscale difference 128, the drive chip obtains a second grayscale difference 7 corresponding to the first grayscale difference 128 from the compensation table, where the second grayscale difference 7 is a difference between the first grayscale difference and a target grayscale 1. Then, the first grayscale difference 127 and the second grayscale difference 7 are added up to obtain the target grayscale 135. After that, the first data line is controlled to input the second data signal to the i-th row of subpixels, where a data signal corresponding to the target grayscale 135 is taken as the second data signal.

In an embodiment, the drive chip is configured to calculate, after obtaining the first grayscale difference, to obtain the second data signal, and control the first data line to input the second data signal to the i-th row of subpixels. Meanwhile, the drive chip first obtains the first grayscale difference 128 between the second grayscale 128 corresponding to the first data signal inputted to the i-th row of subpixels within the first region 100 and the first grayscale 0, and then directly calculate to obtain a value of the second data signal that is needed to input when the first grayscale difference is 128. After that, the first data line is controlled to input the second data signal to the i-th row of subpixels, where a data signal corresponding to the target grayscale 135 is taken as the second data signal.

It can be known from above embodiments that in the display device of the present application, before turning on the (i+1)-th row of subpixels within the first region, the i-th row of subpixels within the first region will be compensated based on the first grayscale difference obtained by the drive chip and then the data signal of the (i+1)-th row of subpixels is inputted such that the compensating data signals and the mis-charging data signals of the i-th row of subpixels are cancelled mutually. In such a way, a mis-charging phenomenon is alleviated such that the boundary between adjacent rows of subpixels is clear and display effect is improved.

The present application further provides a terminal, including a display device and a housing, wherein the display device is the aforesaid display device according any of above embodiments.

It can be known from above embodiments that:

The present application provides a display device and a terminal. The display device includes a plurality of subpixels, a plurality of scan lines, a plurality of data lines and a drive chip; the plurality of subpixels, arranged in an array within a display region; the plurality of scan lines, extending along a horizontal direction, wherein the scan lines are disposed at intervals along a vertical direction, each scan line connects to a row of subpixels, and at work stage, the plurality of scan lines input scan signals row by row to control the plurality of subpixels to be turned on row by row; the plurality of data lines, perpendicular to the scan lines, wherein the data lines are disposed at intervals along the horizontal direction, each data line connects to a column of subpixels, and at work stage, the plurality of data lines input data signals to control the turned-on subpixels to display images under grayscales corresponding to the data signals; and the drive chip, configured to store a first grayscale corresponding to a to-be-inputted data signal of an (i+1)-th row of subpixels within a first region, wherein a distance between the first region and scan signal input ends of the scan lines is greater than a threshold, the first region includes at least one column of subpixels, and the drive chip is further configured to obtain a first grayscale difference between a second grayscale corresponding to a first data signal inputted to an i-th row of subpixels within the first region and the first grayscale, and control a first data line corresponding to the subpixels within the first region to input a compensated second data signal to the i-th row of subpixels based on the first grayscale difference before the (i+1)-th row of subpixels are turned on. In the present application, before turning on the (i+1)-th row of subpixels within the first region, the i-th row of subpixels within the first region will be compensated based on the first grayscale difference obtained by the drive chip and then the data signal of the (i+1)-th row of subpixels is inputted such that the compensating data signals and the mis-charging data signals of the i-th row of subpixels are cancelled mutually. In such a way, a mis-charging phenomenon is alleviated such that the boundary between adjacent rows of subpixels is clear and display effect is improved.

In the above embodiments, different emphasis is placed on respective embodiments, and reference may be made to related depictions in other embodiments for portions not detailed in a certain embodiment.

Hereinbefore, a display device and a terminal provided in the embodiments of the present application are introduced in detail, the principles and implementations of the present application are set forth herein with reference to specific examples, descriptions of the above embodiments are merely served to assist in understanding the technical solutions and essential ideas of the present application. Those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present application.

1. A display device, comprising:
a plurality of subpixels, arranged in an array within a display region;
a plurality of scan lines, extending along a horizontal direction, wherein the scan lines are disposed at intervals along a vertical direction, each scan line connects to a row of subpixels, and at work stage, the plurality of scan lines input scan signals row by row to control the plurality of subpixels to be turned on row by row;
a plurality of data lines, perpendicular to the scan lines, wherein the data lines are disposed at intervals along the horizontal direction, each data line connects to a column of subpixels, and at work stage, the plurality of data lines input data signals to control the turned-on subpixels to display images under grayscales corresponding to the data signals; and
a drive chip, configured to store a first grayscale corresponding to a to-be-inputted data signal of an (i+1)-th row of subpixels within a first region, wherein a distance between the first region and scan signal input ends of the scan lines is greater than a threshold, the first region comprises at least one column of subpixels, and wherein after obtaining a first grayscale difference between a second grayscale corresponding to a first data signal inputted to an i-th row of subpixels within the first region and the first grayscale, the drive chip is further configured to control a first data line corresponding to the subpixels within the first region to input a compensated second data signal to the i-th row of subpixels based on the first grayscale difference before the (i+1)-th row of subpixels are turned on.

2. The display device according to claim 1, wherein the drive chip is configured to control the first data line to input the compensated second data signal to the i-th row of subpixels, where a third grayscale corresponding to the second data signal is greater than the second grayscale when the first grayscale difference is a positive value.

3. The display device according to claim 1, wherein the drive chip is configured to control the first data line to input the compensated second data signal to the i-th row of subpixels, where a third grayscale corresponding to the second data signal is less than the second grayscale when the first grayscale difference is a negative value.

4. The display device according to claim 1, wherein the drive chip is configured to look up, after obtaining the first grayscale difference, a compensation table to obtain a target grayscale corresponding to the first grayscale difference, and control the first data line to input the second data signal to the i-th row of subpixels, where a data signal corresponding to the target grayscale is taken as the second data signal.

5. The display device according to claim 1, wherein the drive chip is configured to look up, after obtaining the first grayscale difference, a compensation table to obtain a second grayscale difference corresponding to the first grayscale difference, add up the second grayscale difference and the first grayscale difference to obtain a target grayscale, and control the first data line to input the second data signal to the i-th row of subpixels, where a data signal corresponding to the target grayscale is taken as the second data signal.

6. The display device according to claim 1, wherein the drive chip is configured to calculate, after obtaining the first grayscale difference, to obtain the second data signal, and control the first data line to input the second data signal to the i-th row of subpixels.

7. The display device according to claim 1, wherein the first region is equal to the display region in size.

8. The display device according to claim 1, wherein the scan signal input ends are disposed at a left side or a right side of the display device and the first region is located within the display region at one side away from the scan signal input ends.

9. The display device according to claim 1, wherein the scan signal input ends are disposed at a left side and a right side of the display device and the first region is located at a middle part of the display region.

10. The display device according to claim 1, wherein the drive chip is configured to store the first grayscale corresponding to the to-be-inputted data signal of the (i+1)-th row of subpixels within the first region in a buffer.

11. A terminal, comprising a display device and a housing, the display device comprising:
a plurality of subpixels, arranged in an array within a display region;
a plurality of scan lines, extending along a horizontal direction, wherein the scan lines are disposed at intervals along a vertical direction, each scan line connects to a row of subpixels, and at work stage, the plurality of scan lines input scan signals row by row to control the plurality of subpixels to be turned on row by row;
a plurality of data lines, perpendicular to the scan lines, wherein the data lines are disposed at intervals along the horizontal direction, each data line connects to a column of subpixels, and at work stage, the plurality of data lines input data signals to control the turned-on subpixels to display images under grayscales corresponding to the data signals; and
a drive chip, configured to store a first grayscale corresponding to a to-be-inputted data signal of an (i+1)-th row of subpixels within a first region, wherein a distance between the first region and scan signal input ends of the scan lines is greater than a threshold, the first region comprises at least one column of subpixels, and wherein after obtaining a first grayscale difference between a second grayscale corresponding to a first data signal inputted to an i-th row of subpixels within the first region and the first grayscale, the drive chip is further configured to control a first data line corresponding to the subpixels within the first region to input a compensated second data signal to the i-th row of subpixels based on the first grayscale difference before the (i+1)-th row of subpixels are turned on.

12. The terminal according to claim 11, wherein the drive chip is configured to control the first data line to input the compensated second data signal to the i-th row of subpixels, where a third grayscale corresponding to the second data signal is greater than the second grayscale when the first grayscale difference is a positive value.

13. The terminal according to claim 11, wherein the drive chip is configured to control the first data line to input the compensated second data signal to the i-th row of subpixels, where a third grayscale corresponding to the second data signal is less than the second grayscale when the first grayscale difference is a negative value.

14. The terminal according to claim 11, wherein the drive chip is configured to look up, after obtaining the first grayscale difference, a compensation table to obtain a target grayscale corresponding to the first grayscale difference, and control the first data line to input the second data signal to the i-th row of subpixels, where a data signal corresponding to the target grayscale is taken as the second data signal.

15. The terminal according to claim 11, wherein the drive chip is configured to look up, after obtaining the first grayscale difference, a compensation table to obtain a second grayscale difference corresponding to the first grayscale difference, add up the second grayscale difference and the first grayscale difference to obtain a target grayscale, and control the first data line to input the second data signal to the i-th row of subpixels, where a data signal corresponding to the target grayscale is taken as the second data signal.

16. The terminal according to claim 11, wherein the drive chip is configured to calculate, after obtaining the first grayscale difference, to obtain the second data signal, and control the first data line to input the second data signal to the i-th row of subpixels.

17. The terminal according to claim 11, wherein the first region is equal to the display region in size.

18. The terminal according to claim 11, wherein the scan signal input ends are disposed at a left side or a right side of the display device and the first region is located within the display region at one side away from the scan signal input ends.

19. The terminal according to claim 11, wherein the scan signal input ends are disposed at a left side and a right side of the display device and the first region is located at a middle part of the display region.

20. The terminal according to claim 11, wherein the drive chip is configured to store the first grayscale corresponding to the to-be-inputted data signal of the (i+1)-th row of subpixels within the first region in a buffer.
